(19) United States
(12) Patent Application Publication
(10) Pub. No.: US 2009/0119373 A1
(43) Pub. Date: May 7, 2009

(54) SYSTEM AND METHOD FOR CONTROLLING INSTANT MESSAGING STATUS

(76) Inventors: Gary Denner, Kildare (IE); Patrick Joseph O'Sullivan, Dublin (IE); Carol Sue Zimmet, Boxborough, MA (US); Ruthie D. Lyle, Durham, NC (US)

Correspondence Address: HOLLAND & KNIGHT, 10 ST. JAMES AVENUE, BOSTON, MA, 02116-3889, US

(21) Appl. No.: 11/934,499

(22) Filed: Nov. 2, 2007

(51) Int. Cl. G06F 15/16

(52) U.S. Cl. 709/206

(57) ABSTRACT

A method and computer program product or managing instant messaging status include identifying an instant messaging unavailable status for a user, and identifying a point-in-time collaborative intersection between the user and one or more collaborative users. The instant messaging unavailable status of the user is penetrated to allow instant messaging communications from at least a portion of the one or more collaborative users during the point-in-time collaborative intersection.

### TECHNICAL FIELD

This disclosure relates to instant messaging and, more particularly, to systems and methods for controlling instant messaging status of a user based upon point-in-time collaborative intersections.

### BACKGROUND

Email, instant messaging, text messaging, as well as other communications systems that exist today have converged to leave consumers of the technologies with less control of when and how they are interrupted. Interruptions by way of mail, instant messaging, text messaging, telephone, calendar invites, e-meetings, voice mail, organizational web conferences, cellular, and so on, are hugely time consuming and are oftentimes a nuisance for those who wish to concentrate on a task, or manage their day in relation to tasks they want to get done. Likewise, managers of teams are oftentimes frustrated with outside interruptions distracting members of their team and wish to manage this.

During activities such as teleconferences, web meetings, and the like, users may disable some or all of their communications systems in an attempt to mitigate interruptions. Various communications systems include mechanisms for controlling interruptions, such as do-not-disturb for voice communications and instant messaging. Similarly, email notification systems can be turned off, and so on. While disabling some or all of the communication systems may reduce unwanted interruptions, it may also prevent desired communications. For example, in the case of collaborative activities, such as teleconference, web meetings, and the like, it may be useful for one of the collaborating users to communicate with another collaborating user, while not involving any remaining users in the exchange. However, if one of the collaborating users has disabled some or all of his communication systems, it may not be possible to engage him in a side discussion.

### SUMMARY OF THE DISCLOSURE

In a first implementation, a method includes identifying an instant messaging unavailable status for a user. A point-in-time collaborative intersection between the user and one or more collaborative users is also identified. The instant messaging unavailable status of the user is penetrated to allow instant messaging communications from at least a portion of the one or more collaborative users during the point-in-time collaborative intersection.

One or more of the following features may also be included. The instant messaging unavailable status may includes a do-not-disturb status, or an off-line status. The point-in-time collaborative intersection may include a common activity between the user and the one or more collaborative users. Identifying the point-in-time collaborative intersection may include monitoring collaborative interactions of the user. Monitoring collaborative interactions of the user may include storing a log of collaborative users.

Penetrating the unavailable status of the user may include penetrating the unavailable status of the user based upon, at least in part, a predefined policy. The predefined policy may identify at least a portion of the one or more collaborative users.

Additionally, penetrating the unavailable status of the user may include identifying the instant messaging communications as originating from the one or more collaborative users. The instant messaging communication may be identified as originating from the one or more collaborate users by providing a graphical identifier.

In a second implementation, a computer program product resides on a computer readable medium having a plurality of instructions stored thereon. When executed by a processor, the instructions cause the processor to perform operations including identifying an instant messaging unavailable status for a user. A point-in-time collaborative intersection between the user and one or more collaborative users may also be identified. The instant messaging unavailable status of the user is penetrated to allow instant messaging communications from at least a portion of the one or more collaborative users during the point-in-time collaborative intersection.

One or more of the following features may also be included. The instant messaging unavailable status may include a do-not-disturb status or an off-line status. The point-in-time collaborative intersection may include a common activity between the user and the one or more collaborative users. The instructions for identifying the point-in-time collaborative intersection may include instructions for monitoring collaborative interactions of the user. The instructions for monitoring collaborative interactions of the user may include instructions for storing a log of collaborative users.

The instructions for penetrating the unavailable status of the user may include instructions for penetrating the unavailable status of the user based upon, at least in part, a predefined policy. The predefined policy may identify at least a portion of the one or more collaborative users.

Additionally, the instructions for penetrating the unavailable status of the user may include instructions for identifying the instant messaging communications as originating from the one or more collaborative users. The instructions for identifying the instant messaging communication as originating from the one or more collaborate users may include instructions for providing a graphical identifier.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a status control process and an instant messaging application coupled to a distributed computing network.

FIG. 2 is a flowchart of a process executed by the status control process of FIG. 1.

FIG. 3 diagrammatically depicts an activity monitor coupled to the status control process of FIG. 1.

FIG. 4 shows a status control process user interface.

FIG. 5 shows a status control process user interface.

FIG. 6 shows an instant messaging interface rendered by the status control process, instant messaging server application and/or instant messaging client application of FIG. 1.

FIG. 7 shows an instant messaging buddy list rendered by the status control process, instant messaging server application and/or instant messaging client application of FIG. 1.

FIG. 8 shows an instant messaging chat window rendered by the status control process, instant messaging server application and/or instant messaging client application of FIG. 1.

### DETAILED DESCRIPTION

### System Overview:

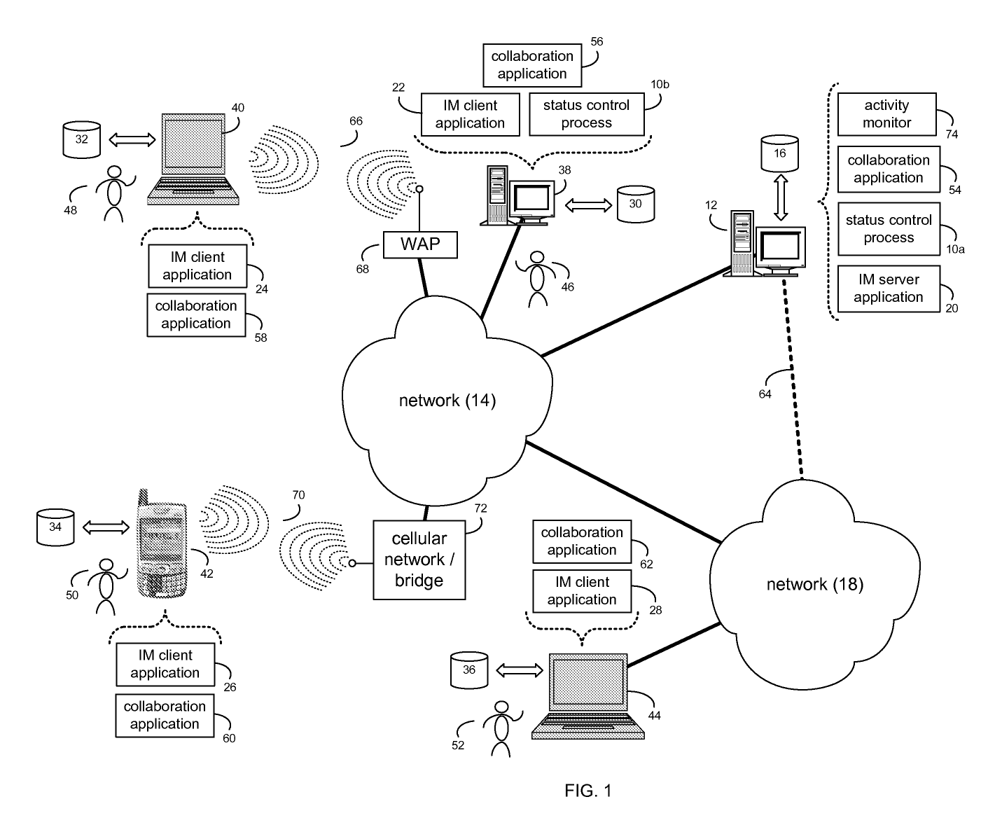

Referring to FIG. 1, there is shown status control process 10a that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally/alternatively, status control process 10b may reside on and be executed, in whole or in part, by a client electronic device, such as a personal computer, notebook computer, personal digital assistant, or the like.

As will be discussed below in greater detail, status control process 10a, 10b may identify an instant messaging unavailable status for a user. Status control process 10a, 10b may also identify a point-in-time collaborative intersection between the user and one or more collaborative users. Status control process 10a, 10b may allow the instant messaging unavailable status of the user to be penetrated to allow instant messaging communications from at least a portion of the one or more collaborative users during the point-in-time collaborative intersection.

The instruction sets and subroutines of status control process 10a, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute instant messaging server application 20, examples of which may include, but are not limited to IBM Lotus Sametime™, Microsoft Office Live Communications Server™, Jabber XCP™, and AOL Instant Messenger™. Instant messaging server application 20 may route instant messages to instant messaging client applications, e.g., instant messaging client applications 22, 24, 26, 28, examples of which may include but are not limited to IBM Lotus Sametime™, Microsoft Office Communicator™, Google Talk™, and AOL Instant Messenger™, for example. Status control process 10a may be a stand alone application that interfaces with instant messaging server application 20 or an applet/application that is executed within instant messaging server application 20.

The instruction sets and subroutines of instant messaging server application 20, which may be stored on storage device 16 coupled to server computer 12, may be executed by one or more processors (not shown) and one or more memory architectures (not shown) incorporated into server computer 12.

As mentioned above, in addition/as an alternative to being a server-side application residing on server computer 12, status control process 10b may be a client-side application residing on one or more client electronic device (e.g., personal computer 38; or client electronic devices 40, 42, 44; not shown). For example, status control process 10b may be stored on storage device 30 (or storage devices 32, 34, 36; not shown). Status control process 10b may be executed by a processor (not shown) and memory architecture (not shown) incorporated into the one or more client electronic devices. Status control process 10b may be a stand alone application that interfaces with an instant messaging client application (e.g., instant messaging client applications 22, 24, 26, 28), or may be an applet/application that is executed within an instant messaging client application. As such, the status control process may be a client-side application (status control process 10b), a server-side process (status control process 10a), or a hybrid client-side/server-based process (e.g., the combination of server-side annotation process 10a and one or more of client-side annotation processes, e.g., 10b), which may be executed, in whole or in part, by server computer 12, and/or one or more of client electronic device (e.g., client electronic devices 38, 40, 42, 44).

The instruction sets and subroutines of instant messaging client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using instant messaging client applications 22, 24, 26, 28, users 46, 48, 50, 52 may access instant messaging server application 20 and may receive, create, and manage instant messages.

Server computer 12 may execute one or more collaboration application 54 which may provide, for example, web meetings, web conferencing, teleconferencing, a chatroom, a team space (e.g., a collaborative website accessible by one or more of users 46, 48, 50, 52), scheduling of meetings and/or activities (e.g., a calendaring application), access to collaborative documents (e.g., a multi-user accessible document library), and/or various other collaborative activities. The instruction sets and subroutines of collaboration application 54, which may be stored on storage device 16 coupled to server computer 12 may be executed by one or more processors (not shown) and one or more memory architectures (not shown) incorporated into server computer 12.

Similarly, one or more client electronic devices (e.g., client electronic devices 38, 40, 42, 44) may execute one or more collaboration applications (e.g., collaboration applications 56, 58, 60, 62), which may allow, for example, participation in web meetings, participation in web conferences, participation in teleconferences, access to chatrooms, access to team spaces, scheduling meetings and/or activities, access to collaborative documents, and/or participation in/access to various other collaborative activities and resources. The instruction sets and subroutines of collaborative applications 56, 58, 60, 62, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Collaborative applications 56, 58, 60, 62 may be stand alone applications and/or may interface/interact with collaborative application 54 on server computer 12.

Users 46, 48, 50, 52 may access instant messaging server application 20 and or collaboration application 54 directly through client electronic devices 38, 40, 42, 44. Users 46, 48, 50, 52 may access instant messaging server application 20 and/or collaboration application 54 directly through network 14 or through secondary network 18. Further, server computer 12 (i.e., the computer that executes instant messaging server application 20 and collaboration application 54) may be connected to network 14 through secondary network 18, as illustrated with phantom link line 64.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 66 established between laptop computer 40 and wireless access point (i.e., WAP) 68, which is shown directly coupled to network 14. WAP 68 may be, for example, an IEEE 802.11a, 802.11b, 802.11g, Wi-Fi, and/or Bluetooth device that is capable of establishing wireless communication channel 66 between laptop computer 40 and WAP 68. Personal digital assistant 42 is shown wirelessly coupled to network 14 via wireless communication channel 70 established between personal digital assistant 42 and cellular network/bridge 72, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Status Control Process:

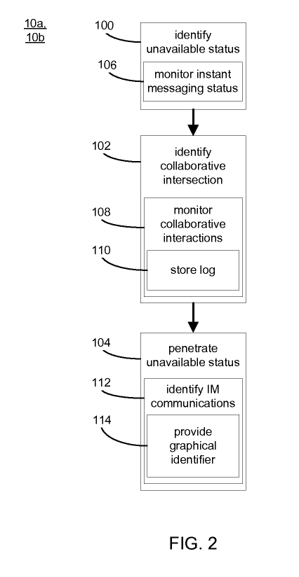

Referring also to FIG. 2, status control process 10a, 10b may identify 100 an instant messaging unavailable status of a user. Status control process 10a, 10b may also identify 102 a point-in-time collaborative intersection between the user and one or more collaborative users. Status control process 10a, 10b may penetrate 104 the instant messaging unavailable status of the user to allow instant messaging communications from at least a portion of the one or more collaborative users during the point-in-time collaborative intersection. As such, status control process 10a, 10b may allow a collaborative user to send an instant messaging communication to a user during a point-in-time collaborative intersection, notwithstanding the instant messaging unavailable status of the user.

The point-in-time collaborative intersection may include a common activity between the user and the one or more collaborative users. For example, user 46 may be engaged in a web conference, e.g., utilizing collaboration application 56 (which may be, for example, a web browser or a web-conferencing specific application) with one or more other users (e.g., user 48 and user 50, utilizing collaboration applications 58, 60, respectively). During the course of the web conference, users 46, 48, 50 may be engaged in a common collaborative activity at the same time giving rise to a point-in-time collaborative intersection (i.e., space-time intersection). Various other examples of collaborative activities may include but are not limited to, meetings (e.g., calendar and scheduling events), presence in team rooms/team spaces (e.g., virtual collaborative environments), chat rooms, as well as various other collaborative activities. As mentioned above, a point-in-time collaborative intersection may occur when user 46 is engaged in a common collaborative activity at the same time as one or more other users (i.e., collaborative users).

Continuing with the above-stated example, in the interest of not being disturbed during the web conference with user 48 and user 50, user 46 may enter into an instant messaging unavailable status (e.g., to prevent outside interruptions). The instant messaging unavailable status may include an instant messaging status in which user 46 may not be able to receive instant messages from other users. The instant messaging unavailable status may include, for example, a do-not-disturb (DND) status or an off-line status, e.g., entered into via a user control in instant messaging client application 22 and/or instant messaging server application 20. Similarly, user 46 may otherwise enter into an instant messaging unavailable status, e.g., instant messaging client application 22 may not be currently running.

To identify 100 the instant messaging unavailable status, status control process 10a, 10b may monitor 106 the instant messaging status of user 46 (e.g., based upon the instant messaging status of instant messaging client application 22). For example, status control process 10a, 10b may interface with instant messaging server application 20 and/or instant messaging client application 22, providing status control process 10a, 10b awareness of user 46's instant messaging status. Similarly, status control process 10a, 10b may “ping” instant messaging client application 22 periodically (e.g., at predetermined time intervals, when status control process 10a, 10b identifies 102 a collaborative intersection, or similar scheme). Status control process 10a, 10b may identify 100 an instant messaging unavailable status of user 46 based upon, at least in part, a response received from instant messaging server application 20 and/or instant messaging client application 22.

Status control process 10a, 10b may monitor 108 collaborative interactions of user 46 to identify 102 collaborative intersection between user 46 and one or more collaborative users (e.g., user 48, and user 50). Continuing with the above-stated example, user 46 may engage in a web conference with user 48 and user 50. Status control process 10, 10b may monitor 108 user 46's usage of collaboration application 56 and/or collaboration application 54 (e.g., which may be web conferencing applications in the above-stated example) and identify 102 that user 46 is engaged in a web conference. Additionally, status control process 10a, 10b may determine (e.g., based upon the details of the web conference, users logged into the web conference, and/or users having the web conference scheduled in a calendar/scheduling application) that user 48 and user 50 are also engaged in the same web conference, thereby establishing a point-in-time collaborative intersection between users 46, 48, and 50.

Status control process 10a, 10b may similarly monitor 108 various other collaborative applications and abstract a point-in-time collaborative intersection. For example, monitoring 108 collaborative interactions of user 46 may be accomplished through various additional and/or alternative mechanisms. For example, collaboration application 54, 56 may be a calendar and scheduling application (e.g., IBM Lotus Notes™, or Microsoft Outlook™, for example). Status control process 10a, 10b may monitor 108 calendar events of user 46 (e.g., a scheduled web conference with user 48 and 50). Based upon the scheduled web conference with user 48 and user 50, which has matured, status control process 10a, 10b may abstract a point-in-time collaborative intersection. As discussed above, the common collaborative activity may include numerous activities other than web conferencing. As such, web conferencing should be understood a being provided merely for illustrative purposes, and should not be construed as limiting this disclosure.

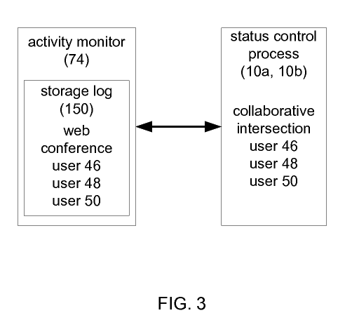

Monitoring 108 collaborative interactions of the user may include storing 110 a log of collaborative users. For example, collaboration process 54, 56 may include a team space (i.e., a virtual collaborative workspace), a shared document library, a web conferencing application, or other collaborative resource. Accessing collaboration process 54, 56 may include logging on to the collaborative resource. Continuing with the above-stated example, and referring also to FIG. 3, users 46, 48, 50 may all be accessing a web conference (e.g., provided by collaboration application 54, 56, 58, 60). Accessing the web conference may require users 46, 48, 50 to log onto the web conference via activity monitor 74 associated with server computer 12. Activity monitor 74 may store 110 a log of users engaged in the collaborative activity, e.g., in storage log 150. Status control process 10a, 10b may monitor 108 collaborative interactions of user 46 based upon the stored 110 log of users (e.g., maintained in storage log 150) that are logged onto the web conference (e.g., users 46, 48, 50) at the same time. Based upon, at least in part, the stored 110 log of users 46, 48, and 50 logged onto the same web conference, status control process 10a, 10b may abstract a point-in-time collaborative intersection between users 46, 48, 50.

Continuing with the above stated example, while users 46, 48, 50 are engaged in the collaborative activity (i.e., users 46, 48, 50 are engaged in the web conference) user 48 may wish to send and instant message to user 46, who is in an instant messaging unavailable status. Status control process 10a, 10b may penetrate 104 the instant messaging unavailable status of user 46 based upon, at least in part, the identified 102 collaborative intersection. Accordingly, user 48 may be able to send an instant message to user 46, notwithstanding user 46's instant messaging unavailable status. Conversely, while user 46, 48, 50 are engaged in the web conference, in which user 52 is not engaged, user 52 may wish to send an instant message to user 46. However, user 52 may not be able to send an instant message to user 46 based upon, at least in part, the instant messaging unavailable status of user 46 and the absence of a collaborative intersection between user 46 and user 52.

Penetrating 104 the instant messaging unavailable status of user 46 may include, for example, penetrating a do-not-disturb status, penetrating an off-line status, or launching instant messaging client application 22. For example, if user 46's instant messaging unavailable status manifest from user 46 entering into an instant messaging do-not-disturb status, status control process 10a, 10b may penetrate the instant messaging do-not-disturb status of user 46. Similarly, if the instant messaging unavailable status manifests from user 46 being in an instant messaging off-line status, status control process 10a, 10b may penetrate the instant messaging off-line status of user 46 (e.g., making user 46 on-line for the purpose of the instant message from user 48). Further, if the instant messaging unavailable status of user 46 is the result of instant messaging client application 22 not currently running, status control process 10a, 10 may penetrate the instant messaging unavailable status of user 46 by launching instant messaging client application 22, allowing user 46 to receive the instant message from user 48.

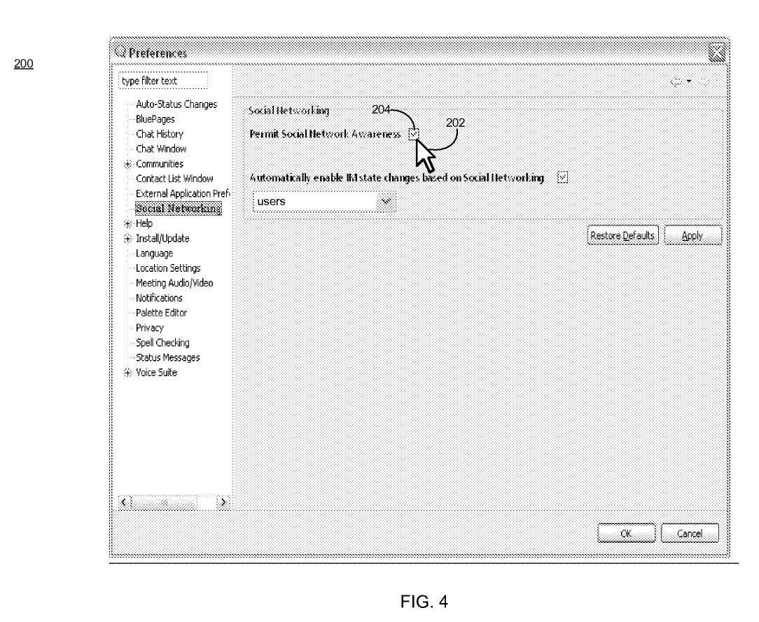

Penetrating 104 the unavailable status of the user may include penetrating the unavailable status of the user based upon, at least in part, a predefined policy. For example, and referring also to FIG. 4, status control process 10a, 10b, instant messaging client application 22, and/or instant messaging server application 20 may provide user interface 200. Via user interface 200 user 46 may establish a policy based upon which user 46's instant messaging unavailable status may be penetrated 104. For example, user 46 may establish a policy to permit or deny social networking awareness in instant messaging. To allow social networking awareness, user 46 may select, via onscreen pointer 202 controlled by a pointing device (e.g., a mouse; not shown), “Permit Social Networking Awareness” check box 204. Selecting check box 204 may result in status control process 10a, 10b establishing a predefined policy allowing collaborative users to penetrate 104 an instant messaging unavailable status of user 46 during a collaborative intersection.

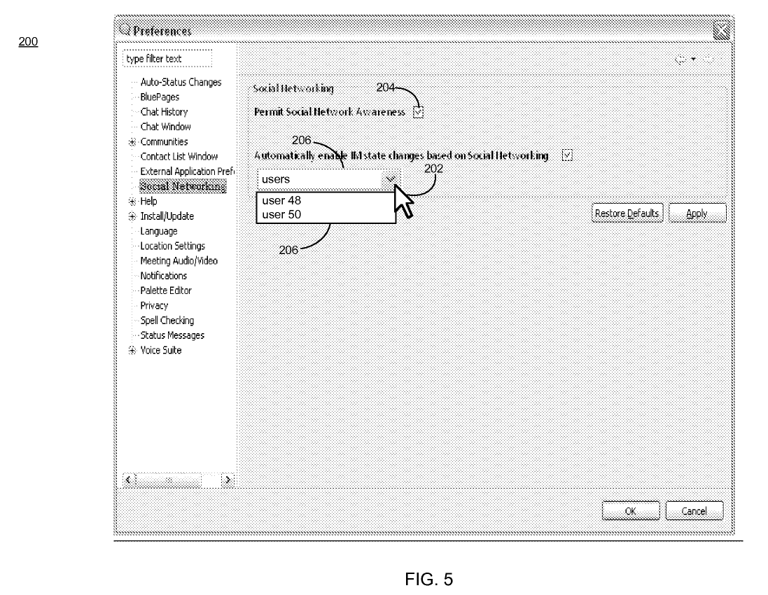

Additionally, the predefined policy may identify at least a portion of the one or more collaborative users that may penetrate 104 the instant messaging unavailable status of the user. Continuing with the above-stated example, user 46 may not, as a general rule wish to allow all collaborative users to penetrate 104 the instant messaging unavailable status during a collaborative intersection. Referring also to FIG. 5, status control process 10a, 10b may allow user 46 to choose which collaborative users may penetrate 104 the instant messaging unavailable status. For example, user 46 may select, via onscreen pointer 202, users drop down 206, resulting in status control process 10a, 10b rendering user menu 208, including collaborative users 48, 50. User 46 may, for example, select user 48 via onscreen pointer 202, resulting in status control process 10a, 10b allowing user 48 to penetrate 104 the instant messaging unavailable status of user 46

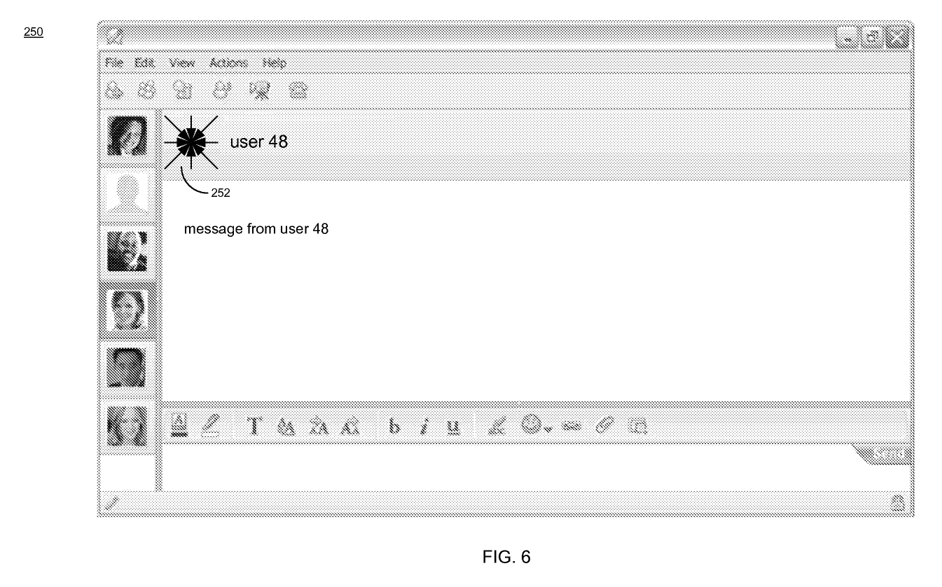

Penetrating 104 the unavailable status of the user may include identifying 112 the instant messaging communication as originating from the one or more collaborative user. For example, during the collaborative intersection, user 48 may send user 46 an instant message. Based upon, at least in part, the collaborative intersection between user 46 and user 48, status control process 10a, 10b may penetrate the instant messaging unavailable status of user 46, allowing user 46 to receive the instant messaging communication from user 48. Status control process 10a, 10b may identify 112 the instant messaging communication as originating from a collaborative user. Referring also to FIG. 6, instant messaging client application 22 may render instant messaging interface 250. Status control process 10a, 10b may identify 112 the instant messaging communication as originating from a collaborative user by providing 114 graphical identifier 252. In addition to graphical identifier 252, various additional features may be used to identify the instant messaging communication as originating from a collaborative user, e.g., font characteristics, color, highlighting, etc.

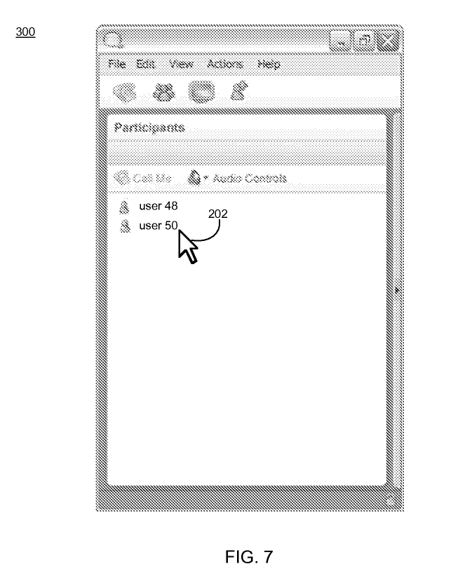

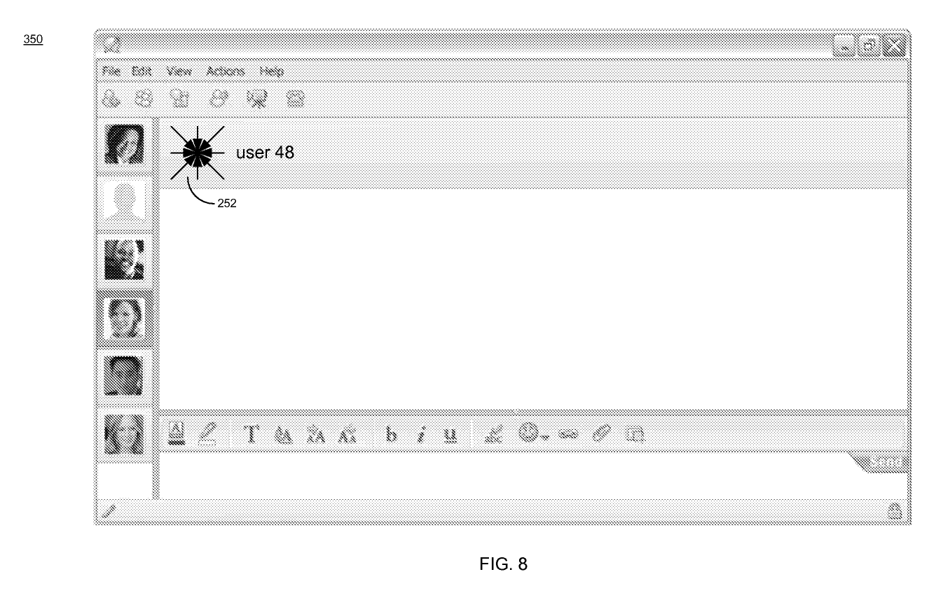

Referring also to FIG. 7, status control process 10a, 10b, instant messaging server application 20, and/or instant messaging client application 22 may provide collaborative intersection buddy list 300. Collaborative intersection buddy list 300 may include a listing of users engaged in the collaborative intersection, facilitating user 46 sending an instant messaging communication to one or more collaborative users (e.g., users 48, 50). For example, and referring also to FIG. 8, by selecting, via onscreen pointer 202, a desired one of the collaborative users (e.g., user 50) may result in instant messaging client application 22 providing instant messaging chat window 350 for sending an instant messaging communication to a collaborative user (e.g., user 50).

A number of implementations have been described. Nevertheless, it will be understood that various modifications may be made. Accordingly, other implementations are within the scope of the following claims.

What is claimed is:

1. A method comprising:
identifying an instant messaging unavailable status for a user;
identifying a point-in-time collaborative intersection between the user and one or more collaborative users; and
penetrating the instant messaging unavailable status of the user to allow instant messaging communications from at least a portion of the one or more collaborative users during the point-in-time collaborative intersection.

2. The method of claim 1, wherein the instant messaging unavailable status includes a do-not-disturb status.

3. The method of claim 1, wherein the instant messaging unavailable status includes an off-line status.

4. The method of claims 1, wherein the point-in-time collaborative intersection includes a common activity between the user and the one or more collaborative users.

5. The method of claim 1, wherein identifying the point-in-time collaborative intersection includes monitoring collaborative interactions of the user.

6. The method of claim 5, wherein monitoring collaborative interactions of the user includes storing a log of collaborative users.

7. The method of claim 1, wherein penetrating the unavailable status of the user includes penetrating the unavailable status of the user based upon, at least in part, a predefined policy.

8. The method of claim 7, wherein the predefined policy identifies at least a portion of the one or more collaborative users.

9. The method of claim 1, wherein penetrating the unavailable status of the user includes identifying the instant messaging communications as originating from the one or more collaborative users.

10. The method of claim 9, wherein identifying the instant messaging communication as originating from the one or more collaborate users includes providing a graphical identifier.

11. A computer program product residing on a computer readable medium having a plurality of instructions stored thereon, which, when executed by a processor, cause the processor to perform operations comprising:
identifying an instant messaging unavailable status for a user;
identifying a point-in-time collaborative intersection between the user and one or more collaborative users; and
penetrating the instant messaging unavailable status of the user to allow instant messaging communications from at least a portion of the one or more collaborative users during the point-in-time collaborative intersection.

12. The computer program product of claim 11, wherein the instant messaging unavailable status includes a do-not-disturb status.

13. The computer program product of claim 11, wherein the instant messaging unavailable status includes an off-line status.

14. The computer program product of claims 11, wherein the point-in-time collaborative intersection includes a common activity between the user and the one or more collaborative users.

15. The computer program product of claim 11, wherein the instructions for identifying the point-in-time collaborative intersection include instructions for monitoring collaborative interactions of the user.

16. The computer program product of claim 11, wherein the instructions for monitoring collaborative interactions of the user include instructions for storing a log of collaborative users.

17. The computer program product of claim 11, wherein the instructions for penetrating the unavailable status of the user include instructions for penetrating the unavailable status of the user based upon, at least in part, a predefined policy.

18. The computer program product of claim 17, wherein the predefined policy identifies at least a portion of the one or more collaborative users.

19. The computer program product of claim 11, wherein the instructions for penetrating the unavailable status of the user include instructions for identifying the instant messaging communications as originating from the one or more collaborative users.

20. The computer program product of claim 19, wherein the instructions for identifying the instant messaging communication as originating from the one or more collaborate users include instructions for providing a graphical identifier.
